(19) United States
(12) Patent Application Publication
(10) Pub. No.: US 2014/0082511 A1
(43) Pub. Date: Mar. 20, 2014

(54) METHOD AND SYSTEM FOR EMULATING DESKTOP SOFTWARE APPLICATIONS IN A MOBILE COMMUNICATION NETWORK

(71) Applicants: Danny Weissberg, Ramat Gan (IL); Ziv Lubinsky, Holon (IL); Oded Edelstein, Haifa (IL)

(72) Inventors: Danny Weissberg, Ramat Gan (IL); Ziv Lubinsky, Holon (IL); Oded Edelstein, Haifa (IL)

(73) Assignee: YUBITECH TECHNOLOGIES LTD., Mobile Post Hefer (IL)

(21) Appl. No.: 13/260,323

(22) PCT Filed: Apr. 6, 2010
(86) PCT No.: PCT/IL2010/000277

§ 371 Date: Jan. 18, 2013

Related U.S. Application Data
(60) Provisional application No. 61/164,921, filed on Mar. 31, 2009.

(51) Int. Cl. H04L 29/08

(52) U.S. Cl. CPC H04L 67/025
USPC 715/740

(57) ABSTRACT

A data processing system for emulating a desktop application desktop software applications in a mobile communication network that comprises (a) an agent for identifying and activating UI objects of a desktop application, and changes in the UI objects (b) a Designer-Tool that is associated with the agent, to generate offline (b.1) a plurality of data sets including representations for objects and states of the desktop application to be converted to corresponding mobile objects and states; (b.2) a plurality of representations of required changes in objects in response to user actions; (b.3) a plurality of data sets for bidirectional mapping between the objects and states of the desktop application and the corresponding mobile objects and states; (c) a user client to control the GUI and represent objects and states of the desktop application and to receive user actions from the GUI; change the represented objects responsive to user actions; and send the user actions to a gateway that is in communication with the user client and with the desktop application via the agent, and during runtime, to (d.1) map the user actions from the user client to corresponding actions in the desktop application to be used by the agent using the datasets; (d.2) receive updated outputs from the desktop application via the agent; (d.3) map the updated output and UI objects to a mobile format, using the datasets; (d.4) send the mapped updated output to the user client; (d.5) manage sessions of users with the desktop applications in the form of service points running on the server or desktop computer.

### FIELD OF THE INVENTION

The present invention relates to the field of software application, and more particularly, to emulating software in a communication network. More particularly, the invention relates to a method for emulating desktop software applications in a mobile communication network.

### BACKGROUND OF THE INVENTION

Mobile phones are no longer stand-alone devices—increasingly, they play the role of enterprise application endpoints. This new character provides new opportunities across the mobile ecosystem, but also challenges handset OEMs to bring feature-rich, enterprise mobile phones to market, quickly and cost-effectively.

Despite obvious similarities between enterprise/desktop virtualization and its mobile counterpart, mobile phone use cases present key differences: smaller memory capacities demand slimmer embedded hypervisor footprints, current mobile processors lack virtualization support in hardware requiring virtualization, and hosted guest software span the gamut from enterprise to stand-alone device drivers.

Evermore software applications are being run on communication device, especially mobile phone. However, mobile phones are still limited in their resources, such as bandwidth, memory, processor and battery. On the other hand, software applications constantly increase their demand for resources. Therefore, in order to remotely operate desktop applications by mobile devices, mobile application developers must write corresponding mobile applications from scratch, so as to make them compatible with the screen size, the resolution and the interface. This virtualization process is of course cumbersome, time consuming and expensive.

Several attempts were made to obtain sufficient virtualization levels of desktop applications, using graphical representation. However, these attempts are still problematic and are not compatible with the limitations of mobile devices, since they check changes in pixel levels on the desktop application and redraw these changes on the client side Redrawing a desktop application on a small mobile screen, using a graphical-based virtualization solution will present a non-usable user experience, squeezing a desktop screen into a small mobile screen. On the other hand, using object-based virtualization enables the re-design of the application appearance to perfectly feet the mobile screen size.

U.S. Patent Publication No. 2006/0030292 discloses an occasionally-connected application server for developing applications for e.g. cell phone, has conduit manager to translate between data from external systems and data nodes defined by occasionally-connected data model.

European Patent No. 0827098 discloses a method of performing interactive applications in client server based dialog system by describing on server side documents with respect to page setup and to page data contents, generates document data independent of system resources, transmits document from server to client to generate document there based on that data.

All the methods described above have not yet provided satisfactory solutions to the problem of virtualization of desktop applications, which does not require writing corresponding mobile applications that are compatible with the resources of mobile devices.

It is an object of the present invention to provide a method and system for virtualization of desktop applications which does not require writing corresponding mobile applications that are compatible with the screen size, the resolution and the interface of mobile devices.

It is an object of the present invention to provide a method and system for virtualization of desktop applications for mobile devices, which is quick and efficient.

Other objects and advantages of the invention will become apparent as the description proceeds.

### SUMMARY OF THE INVENTION

The present invention is directed to a data processing system for emulating an application running on a server (or a desktop computer) onto a client communication device comprising a Graphical User Interface (GUI), and a computer implemented method thereof. The client communication device, which has predetermined capabilities, is connected via a communication link to a Gateway and then to the server (or desktop) running the desktop applications. The desktop application comprises states and objects responsive to user actions. The data processing system comprises a gateway (which is a data set managing module) and a user client on the client communication device. The Mapping managing module on the gateway is a server that is associated with the desktop application, and is arranged to generate the mapping data between the Desktop UI objects and the Mobile UI objects according to the data designed in the designer phase and the Desktop application state in run-time. The user client on the client communication device is arranged to control the GUI and represent objects and states of the desktop application according to the data sent by the gateway (which is created according to the mapping rules). The user client is further arranged to receive user actions from the client's GUI; to change the represented objects according to the representations of required changes responsive to user actions; and to send the user actions to the gateway. The gateway is arranged to map the user actions to the desktop application's UI objects; to receive UI changes from the desktop application; to map the received UI changes to a corresponding mobile data and to send the mapped output to the user client, for updating the displayed screen. Emulating the desktop application on the client communication device allows sustaining real-time user interactions on the client communication device, while running the desktop application on the server (or desktop) and within the resource capabilities of the client communication device.

These, additional, and/or other aspects and/or advantages of the present invention are set forth in the detailed description which follows; possibly inferable from the detailed description; and/or learnable by practice of the present invention.

The features of the present invention will be better understood using the following definitions:

Design-Time: an offline stage during which a mobile application designer generates a plurality of data sets required for: (a) representing selected instances and UI objects of a desktop application in a mobile environment, (b) mapping updates in the desktop applications to corresponding updates in the mobile application (c) mapping end user actions in the mobile application to corresponding actions in the desktop application.

Run-Time: an on-line bidirectional mapping stage, during which updates in the desktop applications are mapped to corresponding updates in the mobile application and end user actions in the mobile application are mapped to corresponding actions in the desktop application, using the data sets generated during the design-time.

Agent: a software component that is capable of externally identifying and activating UI objects of a desktop application, as well as changes in these objects.

Mapping: a technique used to convert UI objects of a desktop application to a corresponding mobile application UI objects and vice versa, for virtualization purposes (desktop application emulation).

User Client: a “thin” program or control module, installed in a mobile device for communicating with a server and for rendering virtualized mobile applications.

Learn-Phase: an offline stage (being part of the design time) during which the desktop application is learned by activating the agent to identify and capture the instances, screens and UI objects of each screen in the desktop application, as well as their properties.

Build-Phase: an offline stage (being part of the design time) during which the mobile application designer generates: (a) mobile screens with mobile UI objects that correspond to screens in the desktop application (b) data sets for mapping screens and their UI objects in the desktop application to corresponding mobile screens with mobile UI objects.

Designer-Tool: a software component that resides on the server or on the desktop computer that runs the desktop application, for allowing the mobile application designer to perform the tasks of the Learn-Phase and the Build-Phase (desktop application mobilization).

Gateway: a server that maps and controls data traffic within a data network, between the desktop application and the user client on the mobile device.

Service Point: a Desktop application client instance running either on a dedicated server or on a Desktop computer.

Hooking: a technique used to alter or augment the behavior of an application (or of a software component) by intercepting function calls, messages or events passed between software components.

In one embodiment, the data processing system is used for emulating a desktop application including states and UI objects responsive to user actions and running on a server or a desktop computer onto a client communication device having a GUI and being connected via a communication link to the server. According to this embodiment, the data processing system comprises:

a) an agent which is associated with the desktop application, for externally identifying and activating UI objects of a desktop application, and changes in the UI objects;
b) a Designer-Tool that is associated with the desktop application via the agent, and is arranged to generate offline:
b.1) a plurality of data sets, each data set comprising a plurality of representations for objects and states of the desktop application to be converted to corresponding mobile objects and states;
b.2) a plurality of representations of required changes in objects in response to user actions;
b.3) a plurality of data sets for bidirectional mapping between the objects and states of the desktop application and the corresponding mobile objects and states;
c) a user client, installed on the client communication device and arranged to control the GUI and represent objects and states of the desktop application according to the plurality of data sets, the user client is further arranged to receive user actions from the GUI; change the represented objects according to the representations of required changes responsive to user actions; and send the user actions to a gateway;
d) a gateway being in communication with the user client and with the desktop application via the agent, and during runtime, being arranged to:
d.1) map the user actions from the user client to corresponding actions in the desktop application to be used by the agent using the datasets;
d.2) receive updated outputs from the desktop application via the agent;
d.3) map the updated output and UI objects to a mobile format, using the datasets;
d.4) send the mapped updated output to the user client;
d.5) manage sessions of users with the desktop applications in the form of service points running on the server or desktop computer;
wherein emulating the desktop application on the client communication device allows sustaining real-time user interactions on the client communication device, while running the desktop application on the server or on the desktop computer and within the capabilities of the client communication device.

The present invention is also directed to a computer implemented method of emulating a desktop application running on a server or desktop computer onto a client communication device comprising a GUI, the desktop application comprising states and objects responsive to user actions. The computer implemented method comprises the following steps:
a) identifying offline, by an agent which is associated with the desktop application and being capable of externally identifying and activating UI objects of a desktop application, and changes in the UI objects, states, objects and object properties of the desktop application;
b) generating offline a data set comprising the UI objects and their dynamic representation;
at runtime:
c) sending, the datasets to a Gateway which further processes the datasets and changes them according to the pre-defined mapping data set of UI objects;
d) sending the processed dataset to the client communication device;
e) presenting a representation of the desktop application on the GUI using the data set, the representation comprising a rendering of the graphical objects;
f) receiving user actions relating to the UI objects;
g) dynamically changing the representation of the UI objects according to the data sets;
h) sending the user actions to the Gateway;
i) mapping, by the gateway, the user actions to corresponding actions in the desktop application;
j) inputting the user actions to the desktop application and receiving its output by the agent; and
k) analyzing the output and sending the analyzed output to the client communication device,
wherein the computer implemented method sustains real-time user interactions on the client communication device, while running the desktop application on the server and within the resource limitations of the client communication device.

During the design time, a plurality of data sets may be generated, where each data set comprises a plurality of representations for the objects and the states of the desktop application, and a plurality of representations of required changes in the objects responding to user actions.

Statistics regarding use of the desktop applications on the client communication device may be gathered and utilized to personalize user experience.

Any desktop application may be converted to a corresponding mobile application by:
a) performing, by the mobile application Designer-Tool, a design phase, during which the desktop application is customized to fit the screen of the mobile, wherein the design phase has a learning part where the desktop screens and their UI objects are added into the object repository and the build phase where mobile pages are built by dragging and dropping UI objects from the desktop application to the mobile client.
b) whenever the user accesses the desktop application functionality, performing, a Run-Time phase, during which the application runs on the mobile device; and
c) displaying the designed mobile adaptation on the screen of the mobile device.

During the design phase, data regarding the UI object in the Desktop Application, the UI objects in the Mobile Application and their mapping relations may be stored in a DataBase.

The communication between the desktop application and the mobile device during runtime may be performed by the gateway and the agent associated with the desktop application.

The client application that runs on the mobile device may be rendered by:

a) receiving meta data from the server or desktop computer that runs the native application;
b) converting the meta data to a UI representation;
c) mapping the UI representation to a mobile representation by the gateway; and
d) mapping via the gateway end-user actions back to the server or desktop computer.

The application that runs on a server may be used for:

a) enabling the connection between to the client application that runs on the mobile device and the Desktop Application that runs on the server or desktop computer;
b) traversing Firewalls;
c) enforcing billing and security policy by using a users database;
d) running a session instance for each mobile connection; and
e) activating a workflow logic.

The UI object information may be obtained by Delegating requests to the appropriate agent, which obtains the information from the native desktop application.

During the design time, the designer may learn a UI object from the Desktop Application by:

a) selecting a UI object by clicking/pointing on the UI objects on the desktop client;
b) sending a request to the appropriate agent, for obtaining the UI object type and properties, which resides in the point in the screen selected by the designer user;
c) creating a data-set output that includes the properties of the selected objects and its parents;
d) sending the information back and sending a Request for obtaining the UI object bitmap, which resides in the point in the screen selected by the designer; and
e) presenting the selected object to the designer using the UI object bitmap.

During the design time, an existing mobile page may be updated by:

a) allowing the designer to select and load an existing mobile page that correspond to an application page;
b) displaying the UI objects of the page in the mobile pane;
c) allowing the designer to update the existing application page properties; and
d) adding or removing a new UI objects to the currently designed page by allowing the designer to drag and drop the UI object from the object repository pane to the mobile pane.

During the RunTime Phase, the application displays the first page and when the user activates UI, the application page changes, or a new page may be created.

The service points may run of a desktop computer of a user, rather than on the server.

Each desktop application converted to a corresponding mobile application, may include:

a) a Desktop-Application Data set, being the UI data associated with the desktop application being mobilized;
b) a mobile application Data set being the UI data associated with the mobile application representation of the mobilized application; and
c) an object Mapping data set being the data that describes the mapping between the Desktop application objects and the mobile objects.

The Desktop-Application Data set may include:

a) desktop UI Object Definitions, being the definitions of desktop objects including the list of the object types in the application for each type of desktop application;
b) a Desktop Object Repository, being the list of Desktop screens and the objects in those screens being captured, during the “learn” phase, used for creating the Mobile pages in the “build” phase.

The Mobile Application Data set may include:

a) Mobile UI Object Definitions being the definition of Mobile objects including the list of the object types in the mobile application; and
b) a Mobile Object Repository being the list of Mobile pages with the objects in the pages.

The Object Mapping data set may include:

a) one-to-one mapping scheme of objects; and
b) data for mapping of complex objects, being one to many or many to one mapping scheme.

The agent may receive updated outputs from the desktop application by hooking to changes in the outputs.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1A is a high level architecture of a data processing system for emulating a desktop application, according to an embodiment of the invention;

FIG. 1B is a high level architecture of a data structure generated by the processing system for emulating a desktop application, according to an embodiment of the invention;

FIG. 2 is a high level schematic flowchart of a computer implemented method of emulating a desktop application running on a server onto a client communication device comprising a GUI and exhibiting resource limitations, according to an embodiment of the invention; and

FIG. 3 is a high level schematic flowchart of additional and optional stages in the computer implemented method, according to an embodiment of the invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

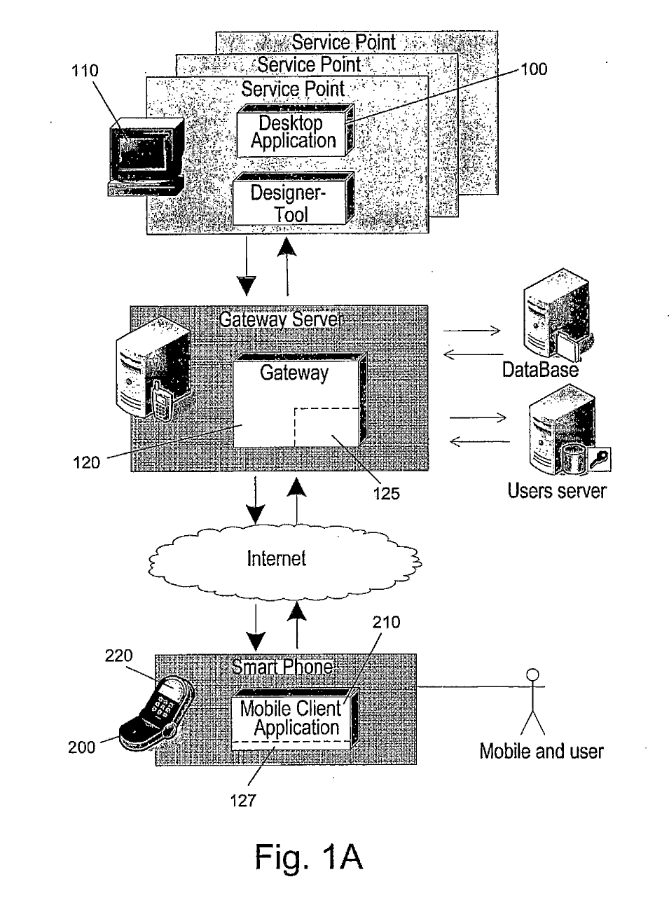

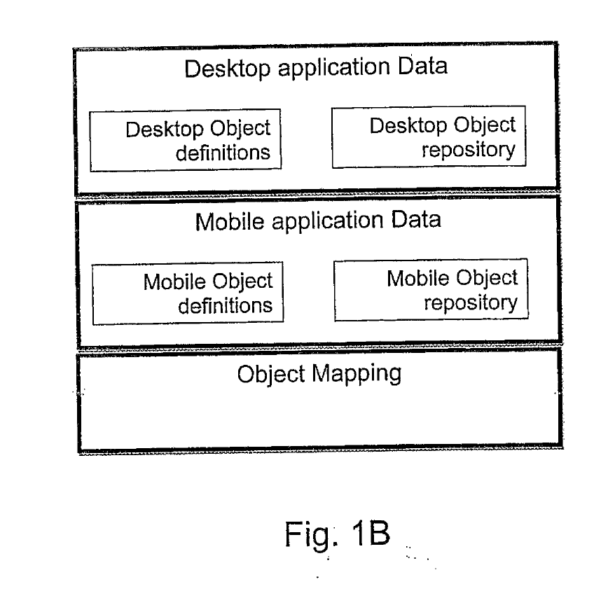

FIG. 1A is a high level schematic block diagram of a data processing system for emulating a desktop application 100, according to an embodiment of the invention. The system is arranged to operate in an offline Design-Time during which the mobile application designer generates data sets for representing UI objects of a desktop application in a mobile environment, mapping updates in the desktop applications to corresponding updates in the mobile application and mapping end user actions in the mobile application to corresponding actions in the desktop application. Then the system is arranged to operate in an on-line Run-Time, during which updates in the desktop applications are mapped to corresponding updates in the mobile application and end user actions in the mobile application are mapped to corresponding actions in the desktop application, using these data sets.

The system comprises a server 110 (or a desktop computer) which runs a desktop application 100 (or which potentially runs multiple instances of the desktop application) and a gateway 120 which is being in communication with the server 110 and with the client communication device 200 over a data network (e.g. the internet).

During runtime, the gateway 120 alters the data UI representation of the desktop application 100 according to mapping data that are prepared and saved offline in the design-phase (by the mobile application designer, using a designer tool that is associated with desktop application 100) UI data representation to be emulated onto a client communication device 200 comprising a GUI 220. Mapping of the gateway 120 is bidirectional: In one direction, it maps UI objects from the desktop application to the corresponding objects in the mobile application (for example, it maps a button in the desktop application to a corresponding mobile button or a checkbox in the desktop application to a corresponding mobile checkbox). In the opposite direction, it maps user actions received from the mobile application on UI objects to the corresponding desktop application UI object and sends a command to the service point (i.e., a desktop client session that runs on the server 110) to initiate the same action in the desktop application (for example, if the user pushes a button in the mobile application, the gateway 120 maps this action and send a command to the service point to activate the corresponding desktop button). In addition, each change or update in the UI objects (e.g., a label) in the desktop application is hooked by the service point and sent to the gateway 120, which maps the updated label to the corresponding mobile label and sends it to the user (mobile) client, which updates the mobile screen accordingly. Therefore, the gateway 120 is responsible for synchronizing between the desktop and the mobile UI objects.

Client communication (mobile) device 200 is connected via a communication link 99 to the Gateway 120 that also manages the connection to the application server 110 to be compatible with the capabilities and resources of the Client communication device 200, such as bandwidth and memory.

The service point on server 110 runs instances of the desktop application and uses an agent which is loaded into the Desktop Application process for performing tasks both during the design and runtime phases. The agent iterates on the UI objects, getting user commands from the gateway and activating the objects in the native application. It is capable of identifying UI objects in the desktop application, activating them externally during runtime and hooking changes in these UI objects during runtime (for example, hooking a new screen, updating a cell in a grid as a result of a user action or of an inherent logic stage). The desktop object identification may be carried out using various methods, such as hooking to objects, searching for tags, receiving Software Development Kit (SDK) calls from hosted application reporting its objects, etc. For each desktop client instance there is a separate agent. There is a specific agent for each Desktop Application type (such as .NET, Standard Window, Java etc), that “understands” the environment of UI objects.

During the design time, the UI object information is obtained by sending a request to the appropriate agent, which obtains the information from the native desktop application. The purpose of this request is to get the UI object type and properties, which resides in the point in the screen selected by the designer user. It then reads the properties of the selected objects and creates output formatted data of this information.

The application designer re-designs the Desktop Application to fit the screen of the mobile device, using the designer tool. During the design phase, data regarding the UI objects in the Desktop Application is retrieved by the agent, the UI objects in the mobile application and their mapping relations is set by the designer user actions and then stored in a database, to be used later at runtime by gateway 120.

Desktop application 100 comprises states and UI objects responsive to user actions. The data processing system allows using the desktop application 100 via client communication device 200 despite the fact that the desktop applications actually running on the server (or on a desktop computer) 110. The emulation generates a mobile interface on GUI 220, which simulates the interface of desktop application 100 by mapping (using gateway 120) the UI objects of desktop application 100 to the client communication device 200.

FIG. 1B is a high level architecture of a data structure generated during the design time, according to an embodiment of the invention. Every desktop application which was converted to a corresponding mobile application has data which is associated to it, which is called herein “Project data” and comprises three sets:

Desktop-Application Data: The first set is the Desktop-Application Data, which is the UI data associated with the Desktop application being mobilized. This data set includes 2 data subsets:

Subset I-Desktop UI Object Definitions: which are the definitions of desktop objects including the list of the object types in the desktop application. Each desktop object is defined by its “type” (e.g., a button, a checkbox, a label etc.), a list of properties, and the actions it supports. Each environment (either .Net, Win32 or Web) has its own Desktop Object Definition. So for example, all .Net applications being mobilized will have the same Desktop Object Definition set. Win32 application being mobilized will have a different Object Definition set.

b. Subset IT-Desktop Object Repository, which is the list of Desktop screens and the objects in those screens being captured, during the “learn” phase in the designer-tool. Those objects will be used later on to create the Mobile pages in the “build” phase of the designer-tool.

Mobile Application Data: The second set is the UI data associated with the Mobile application representation of the mobilized application. If the Desktop application is converted (mobilized) for several mobile devices and platforms, the “Mobile Application Data” will be defined for each different device and platform, since different screen size means different application representation. This Mobile Application data also includes 2 data subsets: Subset I-Mobile UI Object Definitions: which is the definition of Mobile objects includes the list of the object types in the mobile application. Each object type is defined with its “type”, the list of properties, and the actions it supports in the mobile application. Each mobile platform (either BlackBerry, iPhone or Windows-Mobile) has its own Mobile Object Definition. For example, all BlackBerry applications being mobilized, will have the same “Mobile Object Definition” part.

Subset II—Mobile Object Repository: which is the list of Mobile pages with the objects in those pages. Those pages are created during the build phase by the designer tool, by dragging and dropping UI objects from the Desktop object repository to Mobile pages, thereby building the Mobile UI. Alternatively, Subset II may be generated manually by the mobile application designer, during the design time.

### Object Mapping Data:

The third set of the data describes the mapping between the Desktop application objects and the mobile objects. There are 2 types of mapping:
Simple mapping: which is one-to-one mapping of objects, such as Buttons, ChekBox etc;
Complex mapping: mapping of complex objects such as grids and tables. In such cases, the mapping is not one-to-one, but potentially one to many or many to one. For example, a grid in the desktop application may be mapped to 5 objects in the corresponding mobile application.

The mapping data sets are also created during the build phase in the designer tool. Alternatively, the mapping data sets may be generated manually by the mobile application designer, during the design time.

The generated data is stored in a database and are then used by gateway 120 for mapping in run-time. Each project data comprises representations of the UI objects and states of the desktop application 100 (object repository), the UI representation of the mobile pages (potentially there can be several mobile data presentation, for each different mobile platform or device type), and the mapping data describes the relation between the Desktop UI objects and the Mobile UI objects.

Gateway 120 is arranged to identify UI objects and related dynamic information in desktop application 100 and to allow rendering them by the user client 210 on client communication device 200,

Gateway 120 is also arranged to handle various desktop applications 100 and generate UI representation data (according to the Mapping rules) allowing the emulation of each of these various desktop applications 100. The project data comprises Desktop UI representation: Desktop UI object definitions and objects instances including its placement and properties in every particular time. The project also includes the UI representation of one or more Mobile platforms/device types, and the mapping between the Desktop representation and the Mobile representation.

The user client (mobile application) is a “thin client” application that is developed for each Mobile platform, in order to allow the best interactive and native-like user experience. The user client is responsible for receiving mapped UI data representation from the server or desktop computer that runs the native application, and for converting this UI data representation to the Mobile screen. It is also responsible to send user actions back to the server or desktop computer (through the Gateway 120).

According to an embodiment of the invention, user client 210 is arranged to control GUI 220 and represent objects and states of desktop application 100 according to the UI data representation generated by gateway 120. User client 210 and gateway 120 are two coordinated and complementary parts of the data processing system in relation to any desktop application 100, and thus allow the emulation of desktop application 100 running on server 110 onto client communication device 200. User client 210 is further arranged to receive user actions from GUI 220, change the represented objects according to the representations of required changes in response to user actions, and send the user actions to gateway 120 which are then mapped to corresponding actions in the desktop application 100. User actions may comprise, for example, pushing buttons of GUI 220, activating list-controls and radio-buttons, rearranging GUI 220, etc.

According to an embodiment of the invention, user client 210 is integrated in native-OS code or in FLASH (developed by Adobe Systems Inc., San Jose, Calif., U.S.A.) or Silverlight (developed by Microsoft Corporation, Redmond, Wash., U.S.A.) or any other existing framework functionality to implement the data sets on client communication device 200 and receive user actions.

According to an embodiment of the invention, the actual representation of desktop application 100 on GUI 220 on client communication device 200 may be different from the appearance of desktop application 100 on other devices and different from the original GUI of desktop application 100. For example, sizes of icons or of the display may be adapted to client communication device 200's GUI 220.

According to an embodiment of the invention, user client 210 may process user actions and relate user actions to objects and states of desktop application 100 as described in the data sets. For example, GUI actions such as pressing buttons and checking checkboxes may be interpreted into application commands and sent to desktop application 100 as functional actions and not raw data action (e.g. “check checkbox” instead of “press on (x,y) on the screen”), they are further mapped on the Gateway to the corresponding Desktop UI object and action.

According to an embodiment of the invention, gateway 120 is arranged to input the user actions, as received from user client 210 via communication link 99, to desktop application 100. Gateway 120 is further arranged to receive output from desktop application 100, and to map the output to user client 210. The application output is used by user client 210 to activate the consequences of user action according to desktop application 100.

The project data (that consists of Desktop object repository, mobile Application representation and mapping) may be fully downloaded to user client 210 before desktop application 100 starts running. The project information representations may be cached on client communication device 200 due to former or current runs of desktop application 100 on client communication device 200. In such cases, gateway 120 may update cached data set e.g., by proper versioning, i.e., reloading an updated version of desktop application 100 onto client communication device 200 via user client 210. The data set may be downloaded in portions when it is too large to allow rapid starting of the emulation of desktop application 100 on client communication device 200. In such cases, only the essential part of the project may be downloaded at startup (for the first desktop windows and their corresponding Mobile screens). At runtime, each time a new mobile page is to be displayed, which was not cached, additional part of the project will be downloaded from gateway 120. Beside the project data, dynamic information is also sent. This dynamic information is the object properties which are not persistent at each application run (for example, data inside an edit box).

According to an embodiment of the invention, emulating desktop application 100 on client communication device 200 may allow sustaining real-time user interactions on client communication device 200, while running desktop application 100 on server 110 and considering the capabilities of client communication device 200.

According to an embodiment of the invention, gateway 120 is arranged to identify interactive objects and related dynamic information in desktop application 100. Gateway 120 is arranged to allow rendering them through user client 210 on client communication device 200. Identifying the interactive objects allows including their dynamic information in the data sets, thus allowing user client 210 to emulate the applications reactions to user actions that modify the interactive objects.

According to an embodiment of the invention, desktop application 100 may comprise a GUI application of client communication device 200 itself. Thus GUI 220 itself may be emulated on client communication device 200 while the GUI application runs on server 110.

According to an embodiment of the invention, user client 210, data set generating module or an additional analysis module 127 may gather statistics regarding use of desktop applications 100 on client communication device 200. Such statistics may be utilized to learn about preferable desktop applications 100 to the user, and enable giving the user a more personalized user experience. The statistics may further offer the user related applications, optimize the usability according to the most used application, and send related commercials. Analysis module 127 may further record CPU (central processing unit) usage statistics in relation to desktop applications 100 or object rendering in desktop application 100. CPU usage statistics may allow optimizing and personalizing the functioning of client communication device 200.

According to an embodiment of the invention, upon starting desktop application 100, gateway 120 is arranged to send the corresponding data set to client communication device 200 in predefined segments. The predefined segments are selected to allow representing the objects and states of desktop application 100 on GUI 220 substantially immediately after starting desktop application 100. For example, the opening screen and initial options and objects may be included in a first predefined segment of the data set. Until user actions are applied on the initial screen, further predefined segments of the data set may be sent from server 110 to client communication device 200.

According to an embodiment of the invention, the system and method may implement a data set updating module 125 in gateway 120 for optimizing data set updating. Data set updating module 125 may send difference in data sets as data set updates to user client 210 and allow minimizing the updating time. Data set updating module 125 may fully exchange a data set on client communication device 200 only when too many differences are detected.

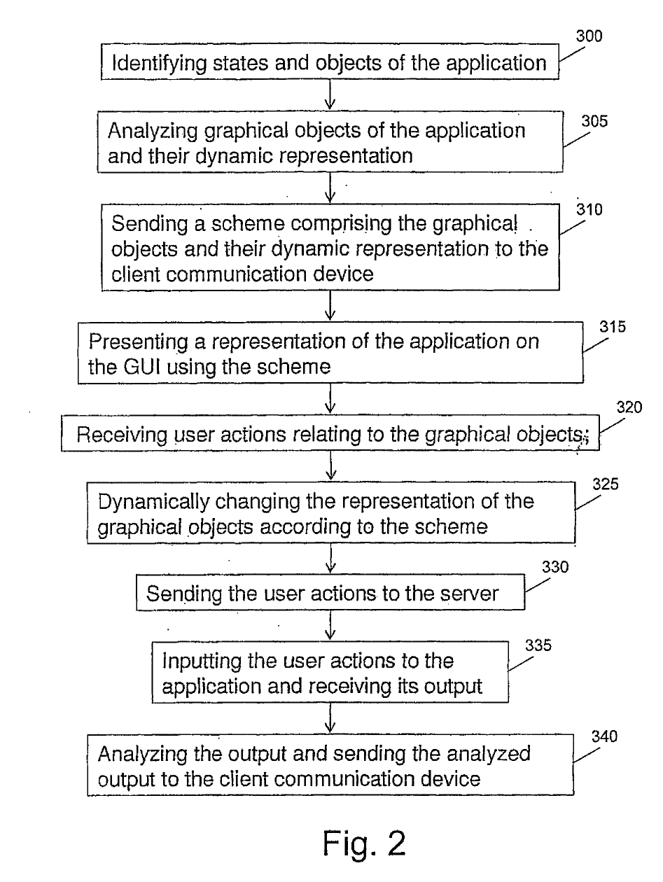

FIG. 2 is a high level schematic flowchart of a computer implemented method of emulating a desktop application running on a server onto a client communication device comprising a GUI and exhibiting resource limitations, according to an embodiment of the invention. The desktop application comprises states and objects responsive to user actions. The computer implemented method comprises the stages of identifying states and UI objects (objects) of the desktop application (stage 300) by an agent that is associated with the running desktop application; analyzing UI objects of the desktop application and their properties and dynamic representation by the agent (stage 305); generating a data set for mapping each UI object to the corresponding mobile application; sending, by the gateway, a data set comprising the graphical objects and their dynamic representation to the client communication device (stage 310); presenting, by the user client, a representation of the desktop application on the GUI using the data set (stage 315), the representation comprising a rendering of the graphical objects; receiving user actions relating to the graphical objects (stage 320); dynamically changing the representation of the graphical objects according to the data set (stage 325); sending the user actions to the gateway, mapping them and sending the mapped data to the agent on the server (stage 330); inputting the user actions to the desktop application and receiving its output by the agent (stage 335); and analyzing the output, mapping it by the gateway using the corresponding data set and sending the analyzed output to the client communication device (stage 340). The computer implemented method sustains real-time user interactions on the client communication device, while running the desktop application on the server and within the resource limitations of the client communication device.

According to an embodiment of the invention, identifying states and objects of the desktop application (stage 300) may be carried out in any of the following ways: (i) automated object identification on Win32, .Net, Web or on any other technology environment (ii) semi automated object identification using image processing and application logic, for example, in games, to identify objects such as Avatars. The object analysis and data set construction may be carried out offline, while object identification may be carried out in runtime; and (iii) third party object reporting using SDK, in XAML (Extensible Application Markup Language) or Adobe Flex (open source framework for building expressive web applications), or different proprietary structure, that requires cooperation from the application developers.

According to an embodiment of the invention, data sets may comprise UI object types (such as buttons, check boxes, list, tables etc), object property list (comprising e.g., state, placement, color, etc.), and object states (comprising their graphical representations, their interaction priorities, etc.). Data sets may further comprise dynamic object information that may be updated during the execution of the application.

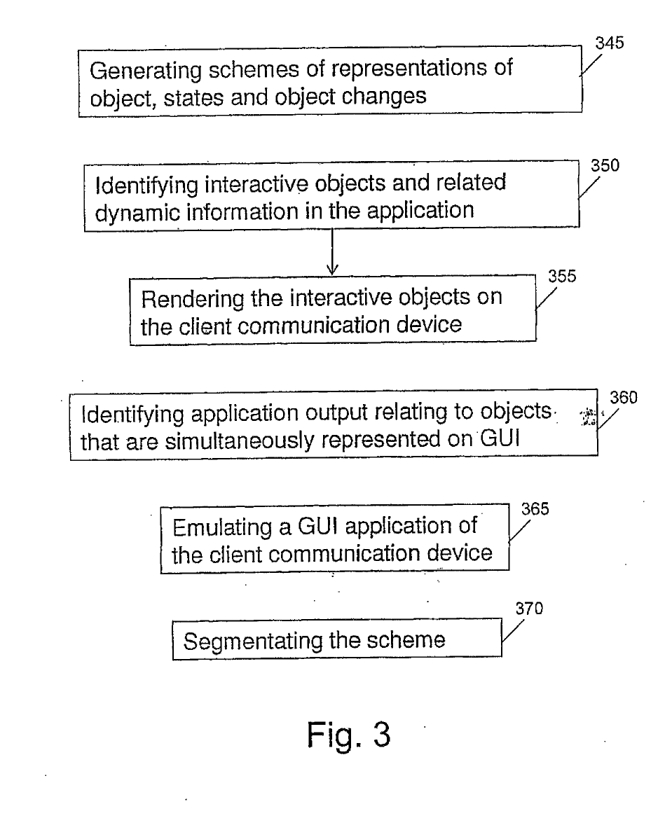

FIG. 3 is a high level schematic flowchart of additional and optional stages in the computer implemented method, according to an embodiment of the invention. Such stages may comprise: generating the data sets by gateway 120 (stage 345), each data set comprising the representations for the objects and the states of the desktop application, as well as the representations of required changes in the objects responding to user actions; identifying interactive objects and related dynamic information in the desktop application (stage 350) and rendering the interactive objects on the client communication device (stage 355); identifying application output relating to objects that are simultaneously represented on the GUI (stage 360); emulating a GUI application of the client communication device (stage 365), such that the GUI application runs on the server and is rendered on the client communication device; and segmentation of the data set (stage 370) such as to allow a substantially immediate starting of the desktop application, wherein the first sent segments are the one required for starting up the desktop application.

According to an embodiment of the invention, the system and method emulate desktop application 110 hosted on server 100 onto client communication device 200 using a thin user client 210. The thinness of the client is enabled by the novel concept of using the object representations and separating immediate reactions to user actions at the GUI level from the actual business logic of the hosted application carried out remotely.

According to an embodiment of the invention, it enables the migration of PC and server desktop applications to mobile phones, without the need to rewrite a corresponding mobile application. The invention is superior to current technological solution such as video based solutions or desktop virtualization solution, because it provides an interactive experience to the user and because it is more optimized in resource utilization and bandwidth, and is hence characterized by lower battery consumption.

According to an embodiment of the invention, desktop application 100 runs on server 110 or on PC side, and a service point on the server side sends to the client some form of display information (for example list of UI objects). A thin-client on the client side renders the information displaying the application picture.

According to an embodiment of the invention, it comprises a revolutionary conceptual solution of presenting a user interface application object instead of raw graphical information (e.g., encoded video frame in case of video based solution, Graphics Device Interface (GDI) commands or Pixel based, in case of desktop virtualization). The present invention identifies high level application information and uses the information in the form of user interface application objects. These objects allow the client to do much more than just rendering a picture. Since it has application level information, it is able to relate to user operations, as operation on identified objects, hence is able to give on client response (for example, a push button will be immediately displayed on the client), creating an interactive user experience. Due to this form of emulation, it requires less data than passing raw graphic information. Hence it will require less network bandwidth, and less CPU, memory and other battery consuming resources.

According to a further embodiment, the service point can also run on one or more desktop computers, rather than on server 110. In this case, the gateway 120 will be adapted to map the commands from the mobile device of the user to a specific desktop computer of a specific user according to credentials of the user (user name, password etc. and the IP of his desktop computer).

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A data processing system for emulating a desktop application including states and UI objects responsive to user actions and running on a server or a desktop computer onto a client communication device having a GUI and being connected via a communication link to said server, the data processing system comprising:
a) an agent which is associated with said desktop application, for externally identifying and activating UI objects of a desktop application, and changes in said UI objects;
b) a Designer-Tool that is associated with said desktop application via said agent, and is arranged to generate offline:
b.1) a plurality of data sets, each data set comprising a plurality of representations for objects and states of said desktop application to be converted to corresponding mobile objects and states;
b.2) a plurality of representations of required changes in objects in response to user actions;
b.3) a plurality of data sets for bidirectional mapping between the objects and states of said desktop application and said corresponding mobile objects and states;
c) a user client, installed on the client communication device and arranged to control said GUI and represent objects and states of said desktop application according to the plurality of data sets, said user client is further arranged to receive user actions from said GUI; change the represented objects according to the representations of required changes responsive to user actions; and send the user actions to a gateway;
d) a gateway being in communication with said user client and with said desktop application via said agent, and during runtime, being arranged to:
d.1) map the user actions from said user client to corresponding actions in said desktop application to be used by said agent using said datasets;
d.2) receive updated outputs from said desktop application via said agent;
d.3) map said updated output and UI objects to a mobile format, using said datasets;
d.4) send the mapped updated output to said user client;
d.5) manage sessions of users with said desktop applications in the form of service points running on said server or desktop computer;
wherein emulating the desktop application on the client communication device allows sustaining real-time user interactions on the client communication device, while running the desktop application on the server or on the desktop computer and within the capabilities of the client communication device.

2. A computer implemented method of emulating a desktop application running on a server or desktop computer onto a client communication device comprising a GUI, the desktop application comprising states and objects responsive to user actions, the computer implemented method comprising:
a) identifying offline, by an agent which is associated with said desktop application and being capable of externally identifying and activating UI objects of a desktop application, and changes in said UI objects, states, objects and object properties of said desktop application;
b) generating offline a data set comprising said UI objects and their dynamic representation;
at runtime:
c) sending, said datasets to a Gateway which further processes the datasets and changes them according to the pre-defined mapping data set of UI objects;
d) sending the processed dataset to the client communication device;
e) presenting a representation of said desktop application on the GUI using the data set, the representation comprising a rendering of the graphical objects;
f) receiving user actions relating to the UI objects;
g) dynamically changing the representation of the UI objects according to said data sets;
h) sending the user actions to said Gateway;
i) mapping, by said gateway, said user actions to corresponding actions in said desktop application;
j) inputting the user actions to said desktop application and receiving its output by said agent; and
k) analyzing the output and sending the analyzed output to the client communication device,
wherein the computer implemented method sustains real-time user interactions on the client communication device, while running the desktop application on the server and within the resource limitations of the client communication device.

3. The method of claim 2, further comprising generating, during the design time, a plurality of data sets, each data set comprising a plurality of representations for the objects and the states of the desktop application, and a plurality of representations of required changes in the objects responding to user actions.

4. The method of claim 2, further comprising gathering statistics regarding use of the desktop applications on the client communication device, and utilizing the statistics to personalize user experience.

5. The method of claim 2, further comprising converting any desktop application to a corresponding mobile application by:
a) performing, by the mobile application Designer-Tool, a design phase, during which the desktop application is customized to fit the screen of the mobile, wherein the design phase has a learning part where the desktop screens and their UI objects are added into the object repository and the build phase where mobile pages are built by dragging and dropping UI objects from the desktop application to the mobile client.
b) whenever the user accesses the desktop application functionality, performing, a Run-Time phase, during which the application runs on said mobile device; and
c) displaying the designed mobile adaptation on the screen of said mobile device.

6. The method of claim 5, wherein during the design phase, data regarding the UI object in the Desktop Application, the UI objects in the Mobile Application and their mapping relations is stored in a DataBase.

7. The method of claim 5, wherein the communication between the desktop application and the mobile device during runtime is performed by the gateway and the agent associated with said desktop application.

8. The method of claim 5, wherein the client application that runs on the mobile device is rendered by:
a) receiving meta data from the server or desktop computer that runs the native application;
b) converting said meta data to a UI representation;
c) mapping said UI representation to a mobile representation by the gateway; and
d) mapping via said gateway end-user actions back to the server or desktop computer.

9. The method of claim 5, wherein the application that runs on a server is used for:
a) enabling the connection between to the client application that runs on the mobile device and the Desktop Application that runs on the server or desktop computer;
b) traversing Firewalls;
c) enforcing billing and security policy by using a users database;
d) running a session instance for each mobile connection; and
e) activating a workflow logic.

10. The method of claim 5, wherein the UI object information is obtained by Delegating requests to the appropriate agent, which obtains the information from the native desktop application.

11. The method of claim 5, wherein the designer learns a UI object from the Desktop Application by:
a) selecting a UI object by clicking/pointing on the UI objects on the desktop client;
b) sending a request to the appropriate agent, for obtaining the UI object type and properties, which resides in the point in the screen selected by the designer user;
c) creating a data-set output that includes the properties of the selected objects and its parents;
d) sending the information back and sending a Request for obtaining the UI object bitmap, which resides in the point in the screen selected by the designer; and
e) presenting the selected object to the designer using said UI object bitmap.

12. The method of claim 5, wherein during the design time, an existing mobile page is updated by:
a) allowing the designer to select and load an existing mobile page that correspond to an application page;
b) displaying the UI objects of said page in the mobile pane;
c) allowing the designer to update the existing application page properties; and
d) adding or removing a new UI objects to the currently designed page by allowing said designer to drag and drop the UI object from the object repository pane to the mobile pane.

13. The method of claim 5, wherein during the RunTime Phase, the application displays the first page and when the user activates UI, the application page changes, or a new page is created.

14. The method of claim 5, wherein the service points run of a desktop computer of a user, rather than on the server.

15. The method of claim 5, wherein each desktop application converted to a corresponding mobile application, includes:
a) a Desktop-Application Data set, being the UI data associated with the desktop application being mobilized;
b) a mobile application Data set being the UI data associated with the mobile application representation of the mobilized application; and
c) an object Mapping data set being the data that describes the mapping between the Desktop application objects and the mobile objects.

16. The method of claim 15, wherein the Desktop-Application Data set includes:
a) desktop UI Object Definitions, being the definitions of desktop objects including the list of the object types in the application for each type of desktop application;
b) a Desktop Object Repository, being the list of Desktop screens and the objects in those screens being captured, during the “learn” phase, used for creating the Mobile pages in the “build” phase.

17. The method of claim 15, wherein the Mobile Application Data set includes:
a) Mobile UI Object Definitions being the definition of Mobile objects including the list of the object types in the mobile application; and
b) a Mobile Object Repository being the list of Mobile pages with the objects in said pages.

18. The method of claim 15, wherein the Object Mapping data set includes:
a) one-to-one mapping scheme of objects; and
b) data for mapping of complex objects, being one to many or many to one mapping scheme.

19. The system of claim 1, in which the agent receives updated outputs from the desktop application by hooking to changes in said outputs.
